(19) United States
(12) Patent Application Publication
(10) Pub. No.: US 2014/0230545 A1
(43) Pub. Date: Aug. 21, 2014

(54) SENSOR AND METHOD OF MAKING A SENSOR

(71) Applicant: Amphenol Corporation, (unknown)

(72) Inventors: David John Geer, Johnsonburg, PA (US); Karen Marie Pistner, Dubois, PA (US)

(73) Assignee: Amphenol Corporation

(21) Appl. No.: 13/773,004

(22) Filed: Feb. 21, 2013

(51) Int. Cl. G01D 11/24; G01K 7/22

(52) U.S. Cl. CPC G01D 11/245; G01K 7/22
USPC 73/431; 374/185; 29/428; 29/592.1

(57) ABSTRACT

A sensor having a metal housing that encloses a sensing device. An end of the housing is crimped, and an overmolding covers the crimped edge and extends from the crimped edge away from the housing.

### BACKGROUND OF THE INVENTION

The subject matter disclosed herein relates to sensors, in particular, to a method and apparatus for mounting a sensor housing to a connector.

Sensor assemblies that are mechanically mounted to connectors in, for example, motors, must be restrained from relative movement with respect to the connectors in order to minimize disconnection incidents or other output anomalies that may result from an insecure mechanical connection. The sensor must be retained in place over its entire operational life in order to reliably provide measured outputs. Conventional methods of mounting a sensor to a plastic overmolding include crosscutting and undercutting a metal housing of the sensor so that the plastic overmolding mechanically secures the sensor to prevent it from being pulled away from the overmolding (axial displacement) or from being twisted in the overmolding (rotational or angular displacement). Other mounting methods include welding and/or screwing a sensor housing in place which results in other disadvantages such as increased time and expense for placing the sensor into operational use

The discussion above is merely provided for general background information and is not intended to be used as an aid in determining the scope of the claimed subject matter.

### BRIEF DESCRIPTION OF THE INVENTION

A sensor having a metal housing that encloses a sensing device and a method of making the sensor is disclosed. The proximal end of the housing is crimped, and an overmolding covers the crimped edge and extends from the crimped edge away from the housing. An advantage that may be realized in the practice of some disclosed embodiments of the sensor is a reduced cost of manufacture because secondary machining or crimping procedures are unnecessary. The crimp can be made during manufacture of the housing using a single extra step to create the crimp.

In one embodiment, a sensor includes a metal housing enclosing a sensing device. The housing has a distal end and a proximal end, with the proximal end being crimped. An overmolding made from an electrically non-conductive material covers the crimped edge and extends away from the housing.

In another embodiment, a temperature sensor includes a housing surrounding a temperature sensing device. The housing includes a crimped end portion and an electrically non-conductive overmolding covering the crimped end portion. The crimped end portion constrains axial and rotational relative displacement of the overmolding.

In another embodiment, a method of making a sensor comprises stamping a metal to form a housing, crimping an edge of the housing, and covering the crimped edge with an electrically non-conductive material. The crimped edge constrains angular and axial displacement of the electrically non-conductive material with respect to the housing.

This brief description of the invention is intended only to provide a brief overview of subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1 is a diagram of an exemplary housing assembly;

FIG. 2 is a diagram of an exemplary sensor assembly;

FIG. 3 is a cross-section side view of the exemplary sensor assembly of FIG. 2;

FIG. 4 is a cross-section longitudinal view of the sensor assembly of FIG. 2;

FIG. 5 is a diagram of a punch and die set for forming the housing of FIG. 1; and

FIG. 6 illustrates a flowchart of a method of making the exemplary sensor assembly of FIG. 2.

### DETAILED DESCRIPTION OF THE INVENTION

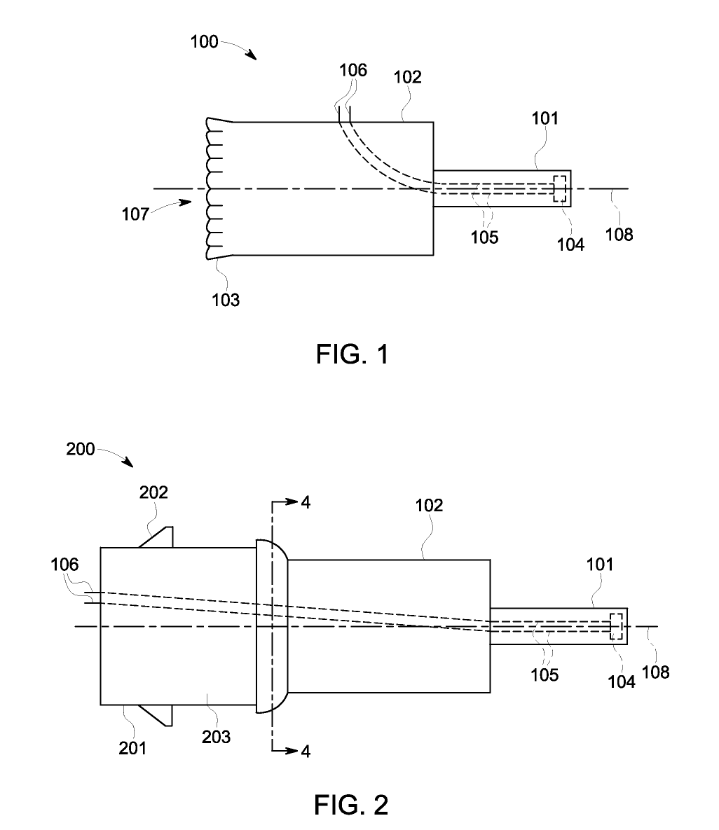

With reference to FIG. 1 there is illustrated a housing assembly 100 comprising a closed-end distal end portion 101 and a open-end proximal end portion 102 each having a substantially cylindrical shape and formed from a substantially continuous single piece of metal, such as brass, but may be made of any suitable thermally conductive material. The substantially cylindrical diameter of the proximal end portion 102 is larger than that of the distal end portion 101. The proximal end portion 102 comprises an annular outwardly crimped proximal edge 103. The crimped edge 103 is shown angled away from a central axis 108 of the housing in the exemplary embodiment of FIG. 1.

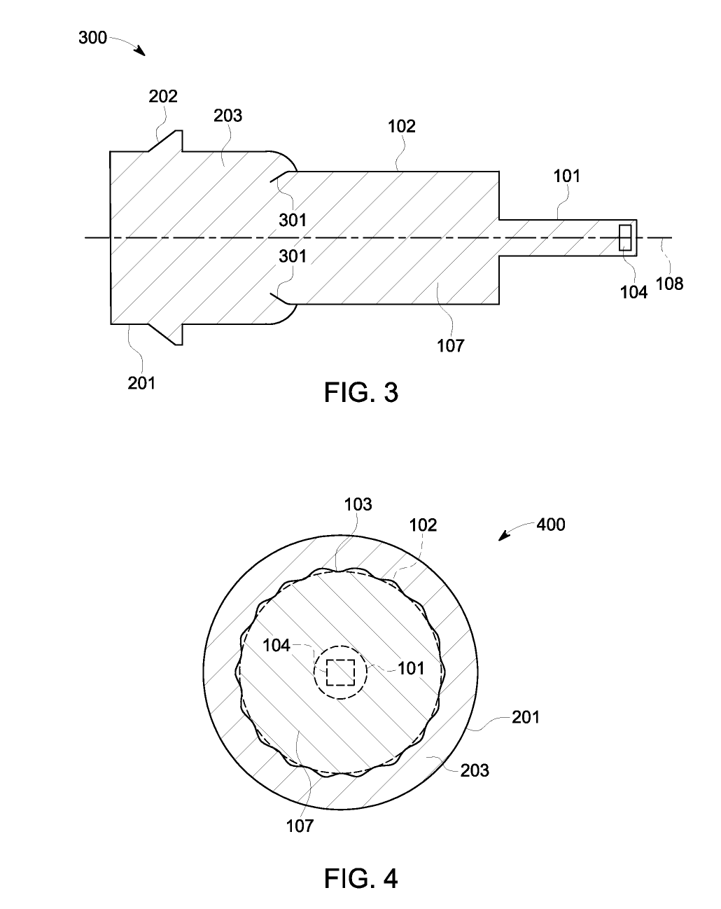

In one embodiment, the outwardly crimped proximal edge 103 may be inwardly crimped as shown in FIG. 3. Although several embodiments discussed herein reference substantially cylindrically shaped distal and proximal ends 101, 102, respectively, it should be noted that the housing assembly 100 may be formed in a variety of non-cylindrical shapes without diminishing advantageous features of the embodiments described herein. Moreover, several embodiments discussed herein reference the distal and proximal ends 101, 102, respectively, as being aligned coaxially. It should also be noted that the distal end portion 101 may be integrally formed with proximal end portion 102 using the methods described below, but in an off-axis orientation with respect to proximal end portion 102.

A sensing device 104 is disposed inside the housing assembly 100 in the distal end portion 101. In one embodiment, the sensing device 104 may comprise a negative temperature coefficient thermistor (“NTC thermistor”). Electrical leads 105 are electrically connected to the sensing device 104 and extend within the housing 100 to terminal access points 106 outside of the housing assembly. In one embodiment, the interior 107 of the housing assembly 100 is filled with, for example, an insulative filler material which serves to fixably secure internal components, such as the aforementioned sensing device 104 and its electrical leads 105, and to structurally support the distal end portion 101 and the proximal end portion 102 of the housing assembly 100. The filler material may include, for particular applications, plastic, elastomer, glass, rubber, other suitably electrically insulative or electrically non-conductive material, or combinations thereof.

The electrical leads 105 may be connected to a display gauge for displaying a numerical magnitude of a parameter, such as temperature, measured and transmitted by the sensing device 104. For example, if the sensing device 104 is a thermistor, then the gauge may be a temperature gauge displaying a temperature reading transmitted by the thermistor over the electrical leads 105. If the thermistor is used in an automotive application such as a coolant temperature sensing device 104, the electrical leads 105 may also be connected to an engine control module for adjusting engine operating parameters in response.

With reference to FIG. 2, there is illustrated a sensor assembly 200 comprising the housing assembly 100 of FIG. 1 having an overmolding 201 covering a portion of the proximal end portion 102 thereof and covering all of the outwardly crimped proximal edge 103. The overmolding 201 may comprise a substantially solid plastic or other electrically insulative material 203 and may be the same material used to fill the housing assembly 100 as described above. The overmolding 201 and the housing assembly 100 electrically insulative material 203 used as a filler therein may be integrally joined, or may be formed at the same time during manufacture. For example, a thermoplastic may be injection molded into the distal 101 and proximal 102 ends of the housing assembly 100 and around the outwardly crimped proximal edge 103 thereby interlocking the housing assembly 100 to the overmolding 201 when the plastic cools around the crimped proximal end 103.

FIG. 2 illustrates that the electrical leads 105 may extend from the sensing device 104 through the electrically insulative material 203 used as a filler toward the overmolding 201, through the overmolding 201, and protrude from the overmolding 201 to provide an alternative electrical terminal access point 106 therefor. The overmolding 201 comprises one or more projections 202 for mechanically securing, such as by a snap-fit, the sensor assembly 200 to a connector such as an electrical connector (not shown) that may electrically communicate with the sensing device 104 via terminal access point 106. Two such projections 202 are illustrated in FIG. 2, however, in other embodiments there may be more or less than two projections 202. There may also be several other types of projections 202, such as ridges, for directing proper orientation of the sensor assembly 200 while it is inserted or otherwise joined or secured to a connector, as described.

The outwardly crimped proximal edge 103 of the housing assembly 100 creates a pattern that interlocks the housing assembly 100 to the overmolding 201, thereby substantially preventing, or resisting, separation or axial displacement of the overmolding 201 and the housing assembly 100. Moreover, it also substantially prevents or resists relative rotation or angular displacement of the overmolding 201 and the housing assembly 100. As mentioned above, the outwardly crimped proximal edge 103 is formed in a same process sequence as the distal 101 and proximal 102 ends of the housing assembly 100 and requires no separate secondary machine processing such as undercutting or crosscutting to provide a secure mechanical attachment for substantially preventing or resisting the aforementioned axial and rotational displacement.

With reference to FIG. 3, there is illustrated a side view cross-section 300 of a sensor assembly similar to that shown in FIG. 2 except that proximal edge 301 is inwardly crimped, that is, the proximal edge 301 of the housing is angled toward central axis 108 and is embedded in a material, such as a plastic material, that also fills an interior 107 of the housing assembly 100. Inwardly crimped proximal edge 301 creates a pattern that interlocks the housing assembly 100 to the overmolding 201 thereby substantially preventing or resisting separation or axial displacement of the overmolding 201 and the housing assembly 100 and also substantially preventing or resisting rotation or angular displacement of the overmolding 201 and the housing assembly 100.

With reference to FIG. 4, there is illustrated a longitudinal cross-section 400 of the sensor assembly 200 illustrating overmolding 201, the open-ended proximal end portion 102 of housing assembly 100, distal end portion 101 of housing assembly 100, sensing device 104 disposed in the distal end portion 101, and plastic fill in the interior 107 of housing assembly 100. The wave-like cross-section pattern formed by inwardly crimped proximal edge 301 that is embedded in the plastic of the overmolding 201 prevents angular displacement of the overmolding 201 and the housing assembly 100. A similar pattern, though having a wider diameter, is formed in the plastic overmolding 201 by the outwardly crimped proximal edge 103 and similarly substantially prevents or resists angular displacement of the overmolding 210 and the housing assembly 100.

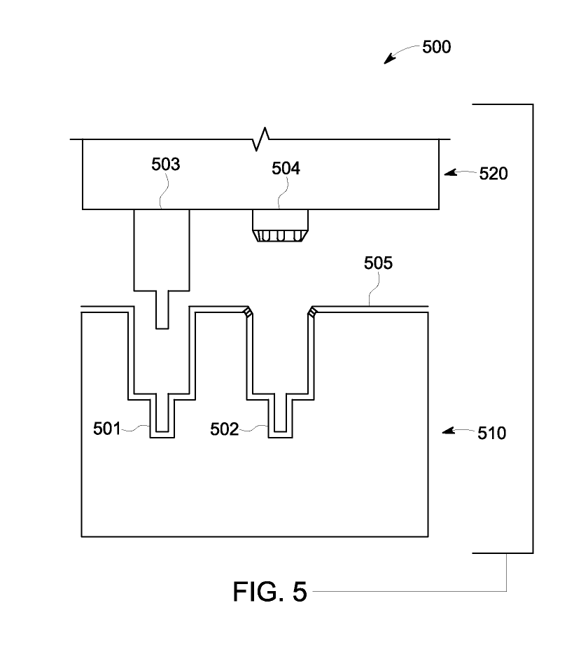

Referring to FIG. 5, there is illustrated a deep draw punch and die process 500 for making the metal housing of housing assembly 100. A punch set 520 comprises a first punch 503 having a contour for shaping the proximal 102 and closed-end distal end portion 101 of the metal housing using the metal strip 505 positioned on die 510 when the first punch 503 is mechanically pushed into die 501. A second punch 504 forms the outwardly crimped proximal edge 103 of housing assembly 100 when the second punch 504 is mechanically pushed into die 502. A progressive die set 510 comprises die 501 corresponding to punch 503 and die 502 corresponding to punch 504 for shaping the metal strip 505 into the final form of the metal housing. As is well known, the deep draw process illustrated in FIG. 5 may include one or more punches in punch set 520, and one or more corresponding dies in die set 510 for progressively shaping metal strip 505 during preceding process steps to arrive at the final punch and die steps as illustrated in FIG. 5. To form the inwardly crimped proximal edge 301, a separately configured punch replaces punch 504 to impart a crimp that bends the edge of proximal end portion 102 inward towards central axis 108 of the sensor assembly 200.

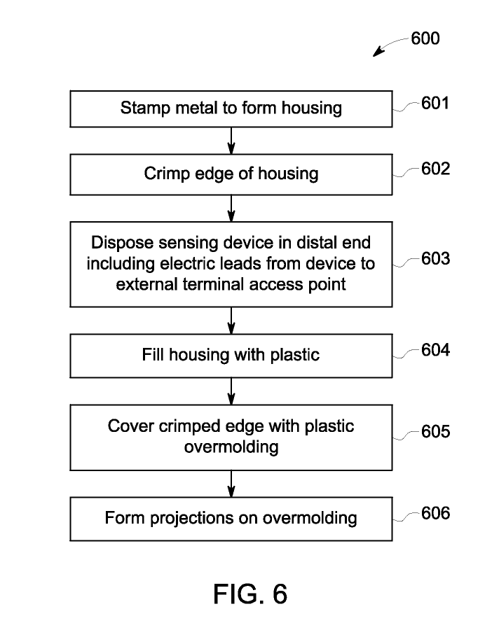

With reference to FIG. 6, a flowchart depicting a process 600 for making the sensor assembly 200 is illustrated. At step 601, a metal strip 505, such as a brass metal strip, is positioned on a die 510 and is stamped or punched using two or more punches 503, 504 and corresponding dies 501, 502 to form the metal strip 505 into a housing suitable for receiving and enclosing a sensing device. At step 602, a proximal edge of the proximal end portion 102 of the housing is crimped inwardly 301 or outwardly 103 so as to provide a pattern in the metal housing that will interlock with a plastic overmold 201 when the housing is embedded therein. Such an interlock substantially prevents, or constrains, radial and axial displacement of the housing assembly 100 from the overmolding 201. At step 603, a sensing device 104, such as an NTC thermistor, with attached electrical leads 105 is placed in the housing, preferably at a distal end portion 101 of the housing, and the electrical leads 105 are routed to an external terminal access point 106 to provide access thereto for electrical communication with the sensing device 104 by separate devices. At step 604, the housing is filled, using an injection molding step, for example, with plastic or other suitable material, such as an electrical insulator, and embeds the sensing device 104 and electrical leads 105 in the plastic fill. At step 605, the plastic injection molding of step 604 may continue so as to form a plastic overmolding 201 that covers the crimped edge 103 of the housing. At step 606, projections 202 may be formed on the plastic overmolding 201 that may be used to fixably attach the overmolding 201 to a connector from another electrical device, such as a snap-fit connector, which itself may make electrical contact with the terminals 106 of the electrical leads 105 to electrically communicate with the sensing device 104.

In view of the foregoing, embodiments of the invention provide a sensor assembly that is formed from a standard metal fabrication process having the added step of crimping an edge of the housing for providing a pattern that interlocks with the overmolding, thereby resisting rotational and axial displacement between the housing and the overmolding. A technical effect is to reduce and simplify fabrication steps used for making the sensing assembly.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A sensor comprising:
a housing made from a metal and having a distal end and a proximal end, the housing enclosing a sensing device, the proximal end comprising an annular edge that is crimped; and
an overmolding made from an electrically non-conductive material covering the annular edge and extending from the annular edge away from the housing.

2. The sensor of claim 1, wherein the distal end and the proximal end of the housing are each formed substantially in the shape of a cylinder, the proximal end having a larger diameter than the distal end, and wherein the distal end and the proximal end are coaxially aligned.

3. The sensor of claim 1, wherein the housing is filled with the electrically non-conductive material.

4. The sensor of claim 3, further comprising electrical leads electrically connected to the sensing device and extending through the electrically non-conductive material inside the housing and through the overmolding, thereby providing electrical terminals for electrically communicating with the sensing device.

5. The sensor of claim 3, further comprising electrical leads electrically connected to the sensing device and extending through the electrically non-conductive material inside the housing and through a side of the proximal end, thereby providing electrical terminals for electrically communicating with the sensing device.

6. The sensor of claim 1, wherein the housing is filled with an electrically non-conductive material different from the overmolding.

7. The sensor of claim 1, wherein the annular edge is crimped inwardly toward an axis of the sensor.

8. The sensor of claim 1, wherein the annular edge is crimped outwardly away from an axis of the sensor.

9. The sensor of claim 1, wherein the overmolding comprises projections formed thereon for mechanically connecting the sensor to a connector.

10. The sensor of claim 1, wherein the sensing device comprises a negative temperature coefficient thermistor.

11. A temperature sensor comprising:
a temperature sensing device;
a housing surrounding the temperature sensing device and comprising a crimped end portion;
an electrically non-conductive overmolding covering the crimped end portion and secured to the housing by the crimped end portion, wherein the crimped end portion constrains axial and rotational relative displacement of the overmolding.

12. The temperature sensor of claim 11, wherein the distal end and the proximal end of the housing are coaxially aligned.

13. The temperature sensor of claim 11, wherein the housing is filled with electrically non-conductive material.

14. The temperature sensor of claim 13, further comprising electrical leads electrically connected to the sensing device and extending through the housing.

15. The temperature sensor of claim 11, wherein the crimped end portion is crimped inwardly toward an axis of the temperature sensor.

16. The temperature sensor of claim 11, wherein the crimped end portion is crimped outwardly away from an axis of the temperature sensor.

17. A method of making a sensor, the method comprising:
die stamping a metal to form a housing;
crimping an edge of the housing; and
covering the crimped edge with an electrically non-conductive material, the crimped edge for constraining an angular displacement and an axial displacement of the electrically non-conductive material with respect to the housing.

18. The method of claim 17, further comprising disposing a sensing device inside the housing at a distal end of the housing and connecting electrical leads to the sensing device, the electrical leads extending from the sensing device to an access point outside of the housing.

19. The method of claim 17, further comprising forming the electrically non-conductive material into an overmolding having projections thereon for mechanically securing the sensor to a connector.

20. The method of claim 17, further comprising filling an interior of the housing with the electrically non-conductive material.
